(19) United States
(12) Patent Application Publication
(10) Pub. No.: US 2008/0038185 A1
(43) Pub. Date: Feb. 14, 2008

(54) Production of export steam in steam reformers

(76) Inventors: Christian Freitag, Munchen (DE); Dino Henes, Munchen (DE); Stefano Innocenzi, Munchen (DE); Harald Klein, Wolfratshausen (DE); Josef Schwarzhuber, Wolnzach (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/790,284

(22) Filed: Apr. 24, 2007

(30) Foreign Application Priority Data
Apr. 25, 2006 (DE) 102006019100.5

(51) Int. Cl. C01B 3/02

(52) U.S. Cl. 423/580.1; 423/648.1; 165/104.21

(57) ABSTRACT

A process and apparatus are provided for generating steam in steam reformation processes in which at least one first steam stream and one second steam stream are generated. The first steam stream (process steam) is preferably completely used in the steam reformation process, while the second steam stream (export steam) can be utilized externally. The export steam is generated preferably solely by vaporizing degassed and demineralized water (high purity water).

The invention relates to a process for generating steam in steam reformation processes in which at least one first steam stream and one second steam stream are generated, wherein the first steam stream (process steam) is completely used in the steam reformation process, while the second steam stream (export steam) is utilized externally, and also to an apparatus for carrying out the process.

In steam reformation processes, hydrocarbon-containing feedstocks such as natural gas, light petroleum or naphtha are mixed with steam and reacted in steam reformers to give synthesis gas, a gas mixture containing carbon monoxide (CO) and hydrogen (H₂). From the synthesis gas, by purification and fractionation in further process steps, substances such as CO, H₂ or oxo gas (a defined mixture of H₂ and CO) are obtained and given off as products. In order to react the hydrocarbons used with a high degree of conversion, the steam reformation in such processes is usually carried out with a steam excess. In order to remove the excess water, the synthesis gas generated in this manner is cooled to below the dew point of water vapour, as a result of which the steam condenses out and what is termed process condensate forms which is predominantly made up of water and is generally loaded with impurities such as methanol, ammonia, carbon dioxide, formic acid and acetic acid.

According to the prior art, the process condensate is mixed with demineralized water which is customarily supplied to the process from the outside. The mixed water thus formed is subsequently degassed and vaporized against mass streams being cooled or coolable in the steam reformation process. After the steam is superheated against coolable exhaust gases, a part of the steam (process steam) is used internally in the process, while the remaining residue (export steam) is not utilized within the steam reformation process, but in an external process. The generation of export steam makes it possible to utilize heat which cannot be utilized in the steam reformation process and to increase the economic efficiency of the steam reformation process.

Frequently, the demands made of the quality of the export steam by the consumers are so high that they cannot be met by an export steam generated in the manner described above. For instance, the electrical conductivity, for example, of export steam which is to be utilized in a condensation turbine must be no greater than 0.2 μS/cm, a value which is frequently exceeded, however, owing to the impurities present in the process condensate. In order, even in such cases, not to have to dispense with the production of export steam, processes exist which provide purification of the process condensate before it is mixed with demineralized water.

For purifying the process condensate, processes are known in which the unwanted substances are separated off by stripping in stripping columns. As stripping gas, use is made in such cases of mass streams (for example natural gas) containing air or hydrocarbons.

In other processes, the process condensate is expanded and subsequently degassed in a scrubbing column using low-pressure steam, air or nitrogen. The impurities are passed out into the open in this case together with the purification medium. In order to be able to meet even high requirements of purity of the steam generated, these processes provide a further purification step by ion exchange in corresponding reactors.

In order to generate export steam of high purity in a steam reformation process of the prior art, considerable use of apparatus (stripping columns, ion exchangers) and thereby also capital expenditure, are necessary. In addition, in some circumstances the amount of export steam decreases, since the energy required for purification can no longer be recovered.

### SUMMARY OF THE INVENTION

An aspect of the present invention is to provide a process of the type mentioned above which permits export steam to be generated with high purity, but without the disadvantages of the prior art, and also a apparatus for carrying out the process.

Upon further study of the specification and appended claims, further objects, aspects and advantages of this invention will become apparent to those skilled in the art.

These aspects can be achieved in accordance with the invention by generating export steam exclusively by vaporizing degassed and demineralized water (high purity water), preferably exclusively by vaporizing degassed and demineralized water.

The fraction of the high purity water intended for generating export steam and also the fraction of the high purity steam intended for export are not mixed with other mass streams in the steam reformation process, in particular not with process condensate or process steam. The purity of the export steam is thereby determined exclusively by the purity of the high purity water. Expediently, the high purity water is produced from drinking water or from water having only low amounts of impurities in water treatment processes as are sufficiently known from the prior art.

The export steam is superheated, and/or the high purity water is vaporized, according to the invention by indirect heat exchange with mass streams to be cooled and/or coolable in the steam reformation process. “Mass streams to be cooled” in this case is to be taken to mean those mass streams which must be cooled in the steam reformation process in order to obtain the desired products. One example of such a mass stream is a synthesis gas stream which exits hot from a steam reformer and must be passed cold into a fractionation device. “Coolable mass streams” is to be taken to mean mass streams which can be cooled, for example for reasons of improved energy utilization, but not cooling them has no effect on the amount and quality of the products to be produced. One example of such a mass stream is the hot exhaust gas flowing out of the steam reformer.

An embodiment of the process according to the invention provides that the process steam is generated from condensate (process condensate) produced in the steam reformation process and predominantly made up of water, or from a mixture of process condensate and high purity water. Preferably, process condensate and high purity water are mixed, the resultant liquid mixture is vaporized by heating and the steam stream thus generated, if appropriate after superheating, is passed on further as process steam. Another preferred embodiment of the process according to the invention provides that process condensate and high purity water are converted separately into the steam phase. The steam streams thus generated are subsequently combined and, if appropriate after superheating, passed on as process steam.

According to another process embodiment of the invention, the process comprises:
generating at least one first steam stream in a steam reforming process by vaporizing a water stream through indirect heat exchange with synthesis gas discharged from the steam reformer and/or exhaust gas discharged from the steam reformer,
generating at least one second steam stream in the steam reforming process by vaporizing a water stream through indirect heat exchange with synthesis gas discharged from the steam reformer and/or exhaust gas discharged from the steam reformer,
using the at least one first steam stream completely in the steam reformation process as steam feed for the steam reformer, and
discharging the at least one second steam stream from the steam reforming process for use externally,
wherein the at least one second steam stream is generated by vaporizing degassed and demineralized water.

The process steam is superheated and/or the process condensate or a mixture of process condensate and high purity water is vaporized according to the invention by indirect heat exchange with mass streams to be cooled and/or coolable in the steam reformation process.

The invention further relates to a apparatus for generating steam in a steam reformation device (steam reformer) in which at least one first steam stream and one second steam stream are generated, wherein the first steam stream (process steam) is used completely within the steam reformer, while the second steam stream (export steam) is utilized externally.

According to an apparatus embodiment of the invention, the steam reformer is equipped with a unit for generating export steam to which degassed and demineralized water (high purity water) can be fed. Preferably, the water fed to the unit is solely degassed and demineralized water.

According to another apparatus embodiment of the invention, the apparatus comprises:
a steam reformer having inlet means for introducing hydrocarbon feed and steam, a first outlet means removing exhaust gas, and a second outlet means removing synthesis gas,
means for generating at least one first steam stream by vaporizing a water stream through indirect heat exchange with synthesis gas discharged from the steam reformer and/or exhaust gas discharged from the steam reformer,
means for generating at least one second steam stream by vaporizing a water stream through indirect heat exchange with synthesis gas discharged from the steam reformer and/or exhaust gas discharged from the steam reformer,
means for conveying the at least one first steam stream from the means for generating to the inlet means for introducing hydrocarbon feed and steam to the steam reformer,
means for conveying the at least one second steam stream from the steam reforming system to an external use, and
means for conveying a degassed and demineralized water stream to the means for generating at least one second steam stream wherein the at least one second steam stream is generated by vaporizing degassed and demineralized water.

A preferred embodiment of the apparatus according to the invention provides that the unit for generating export steam comprises heat exchangers which remove heat off from mass streams to be cooled and/or which are coolable by indirect heat exchange, and can transfer heat to high purity water and/or steam generated from high purity water.

A further preferred embodiment of the apparatus according to the invention provides that the steam reformer is equipped with a unit for generating process steam to which condensate (process condensate) produced in the steam reformation process, or a mixture of process condensate and high purity water, can be fed.

Another preferred embodiment of the apparatus according to the invention provides that the unit for generating process steam comprises heat exchangers which can remove heat from mass streams to be cooled and/or which are coolable by indirect heat exchange, and can transfer heat to process condensate, a mixture of process condensate and high purity water, steam generated from process condensate, and/or steam generated from a mixture of process condensate and high purity water.

By means of the invention it is possible to utilize in an economical manner the waste heat produced in a steam reformation process by generating export steam even when very high requirements are made of the purity of the export steam. By means of the complete separation of process steam and high purity steam generation, there is no risk of contaminating the export steam by introducing unwanted substances, for example from the process condensate.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 diagrammatically illustrates an embodiment of the invention;

FIG. 2 diagrammatically illustrates another embodiment of the invention; and

FIG. 3 diagrammatically illustrates a further embodiment of the invention.

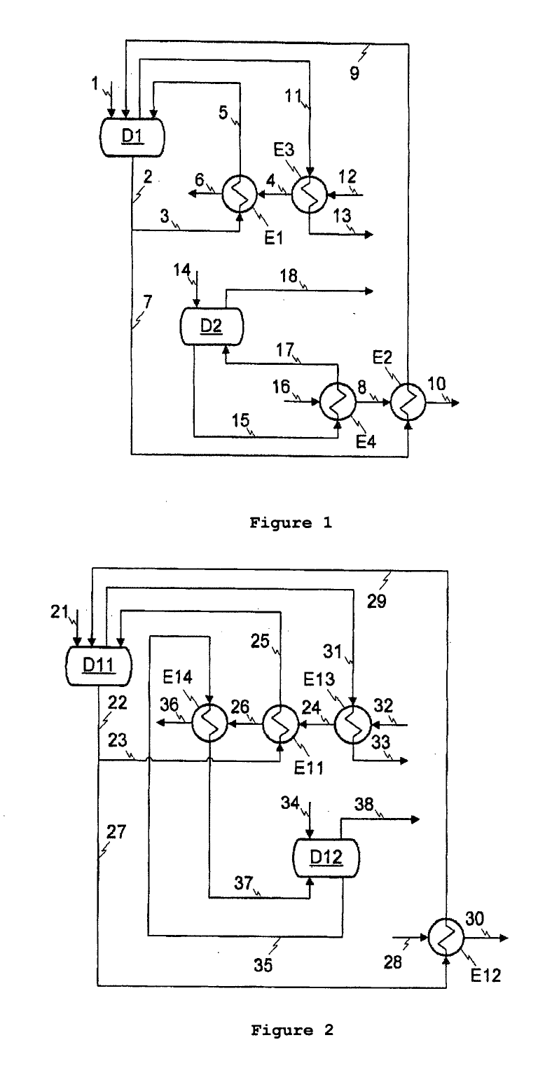

The examples, shown diagrammatically in FIGS. 1 to 3, involve steam reformation processes in which synthesis gas is generated in an externally heated steam reformer from a feed stream containing hydrocarbons and is fed to a fractionation unit for production of products such as, for example, hydrogen and carbon monoxide.

### DETAILED DESCRIPTION OF THE DRAWINGS

In the example shown in FIG. 1, demineralized and degassed import water is introduced via line 1 into the steam drum D1 and mixed with hot water already situated therein. Via line 2, water is taken off from the steam drum D1 and divided into two substreams. The first substream is fed via line 3 to the heat exchanger E1, wherein it removes heat from the exhaust gas stream fed, via line 4, from the steam reformer (which is not shown) and in so doing is in part vaporized. The liquid-steam mixture thus formed is recirculated via line 5 to the steam drum D1 in which liquid and steam are separated, while the cooled exhaust gas stream is passed via line 6 to the stack (which is not shown). The second substream is fed via line 7 to heat exchanger E2 wherein it removes heat from the synthesis gas stream to be cooled, which is fed via line 8, and in so doing is in part vaporized. The liquid-steam mixture thus formed is likewise recirculated via line 9 to the steam drum D1 in which liquid and steam are separated, while the cooled synthesis gas stream is passed onto a fractionation unit (not shown) via line 10. The steam is taken off from the steam drum D1 via line 11 and fed to the heat exchanger E3 which is arranged in the exhaust gas stream line, upstream of the heat exchanger E1. In heat exchanger E3, the steam from steam drum D1 is superheated and, in so doing, removes heat from the hot exhaust gas stream flowing into heat exchanger E3 via line 12. The superheated steam is removed from the heat exchanger E3 via line 13 and passed on as high purity steam.

A mixture of process condensate and high purity water, the purity of which meets internal process purposes, is fed via line 14 to the steam drum D2 and mixed with water already situated therein. Water is removed from the steam drum D2 via line 15 and fed to the heat exchanger E4 wherein it removes heat from the synthesis gas stream fed from the steam reformer via line 16. In so doing, water fed via line 15 is in part vaporized. The liquid-steam mixture thus formed is recirculated via line 17 to the steam drum D2 in which liquid and steam are separated, while the cooled synthesis gas stream is passed on to the heat exchanger E2 via line 8. The steam from the steam drum D2 is taken off via line 18 and passed on as process steam to the steam reformer as feed.

In the example shown in FIG. 2, demineralized and degassed high purity water is introduced via line 21 into the steam drum D11 and mixed with water already situated therein. Water is taken off from the steam drum D11 via line 22 and divided into two substreams. The first substream is fed via line 23 to the heat exchanger E11 wherein it removes heat from the exhaust gas stream fed via line 24. In so doing, the first substream is in part vaporized. The liquid-steam mixture thus formed is recirculated via line 25 to the steam drum D11 in which liquid and steam are separated, while the cooled exhaust gas stream is passed via line 26 to the heat exchanger E14. The second substream is fed via line 27 to the heat exchanger E12 wherein it removes heat from the synthesis gas stream to be cooled, fed via line 28, from the steam reformer (which is not shown) and, in so doing, the second substream is in part vaporized. The liquid-steam mixture thus formed is recirculated via line 29 to the steam drum D11 in which liquid and steam are separated, while the cooled synthesis gas stream is passed on via line 30 to a fractionation unit (not shown). The steam from the steam drum D11 is taken off via line 31 and fed to the heat exchanger E13 arranged in the exhaust gas stream line, upstream of the heat exchanger E11. In heat exchanger E13, the steam from the steam drum D11 is superheated and, in so doing, removes heat from the hot exhaust gas stream fed into heat exchanger E13 via line 32 from the steam reformer (which is not shown). Superheated steam is removed from heat exchanger E13 via line 33 and passed on as high purity steam.

A mixture of process condensate and high purity water, the purity of which meets internal process purposes, is fed via line 34 to the steam drum D12 and mixed with water already situated therein. Via line 35, water is removed from the steam drum D12 and fed to heat exchanger E14 which is arranged downstream of the heat exchanger E11 in the exhaust gas stream. In heat exchanger E14, the water in line 35 removes heat from the exhaust gas stream fed via line 26 from heat exchanger E11. In so doing, the water in line 35 is in part vaporized. The liquid-steam mixture thus formed is recirculated via line 37 to the steam drum D12 in which liquid and steam are separated, while the cooled exhaust gas is passed on via line 36 to the stack (which is not shown). The steam from the steam drum D12 is removed via line 38 and is passed on as process steam to the steam reformer (which is not shown) as feed.

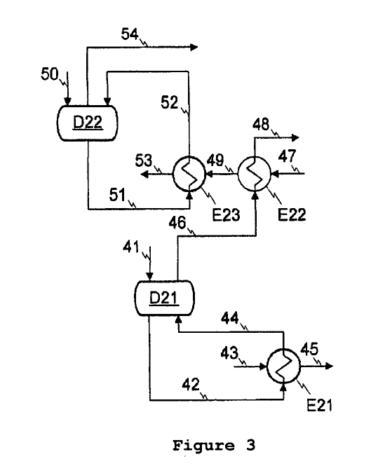

In the example shown in FIG. 3, demineralized and degassed import water is introduced via line 41 into the steam drum D21 and mixed with water already situated therein. Via line 42, water is removed from the steam drum D21 and fed to the heat exchanger E21 wherein the water removes heat from the synthesis gas stream to be cooled fed via line 43 from the steam reformer (which is not shown). In so doing, the water in line 42 is in part vaporized. The liquid-steam mixture thus formed is recirculated via line 44 to the steam drum D21 in which liquid and steam are separated, while the cooled synthesis gas stream is passed on via line 45 to the fractionation unit (not shown). The steam from the steam drum D21 is taken off via line 46, fed to the heat exchanger E22 arranged in the exhaust gas stream of the steam reformer (which is not shown) and superheated there. The energy necessary for the superheating is taken off from the hot exhaust gas stream flowing into the heat exchanger E22 via line 47. Via line 48, the superheated steam is removed from the heat exchanger E22 and passed on as high purity steam.

A mixture of process condensate and high purity water, the purity of which meets internal process purposes, is fed via line 50 to the steam drum D22 and mixed with water already situated therein. Via line 51, water is removed from the steam drum D22 and fed to the heat exchanger E23 arranged downstream of the heat exchanger E22 in the exhaust gas stream. In heat exchanger E23, the water in line 51 removes heat from the exhaust gas stream fed via line 49 and, in so doing, the water is partially vaporized. The liquid-steam mixture thus formed is recirculated via line 52 to the steam drum D22 in which liquid and steam are separated, while the cooled exhaust gas is passed via line 53 to the stack (which is not shown). The steam from the steam drum D22 is removed via line 54 and passed on as process steam to the steam reformer as feed.

The entire disclosures of all applications, patents and publications, cited herein and of corresponding German application No. DE 102006019100.5, filed Apr. 25, 2006, are incorporated by reference herein.

The preceding examples can be repeated with similar success by substituting the generically or specifically described reactants and/or operating conditions of this invention for those used in the preceding examples.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

From the foregoing description, one skilled in the art can easily ascertain the essential characteristics of this invention and, without departing from the spirit and scope thereof, can make various changes and modifications of the invention to adapt it to various usages and conditions.

1. A process for generating steam during steam reformation, said process comprising:
generating at least one first steam stream in a steam reforming process,
generating at least one second steam stream in said steam reforming process,
using said at least one first steam stream completely in the steam reformation process, and
discharging said at least one second steam stream from the steam reforming process for use externally,
wherein said at least one second steam stream is generated solely by vaporizing high purity water, and said high purity is degassed and demineralized water.

2. A process according to claim 1, wherein said at least one first steam stream is generated from condensate produced in the steam reformation process which is predominantly made up of water, or is generated from a mixture of said condensate and high purity water.

3. A process according to claim 1, wherein said at least one second steam stream is generated by superheating and/or vaporizing high purity water through indirect heat exchange against mass streams to be cooled and/or coolable.

4. A process according to claim 1, wherein said at least one first steam stream is generated by:
superheating and/or vaporizing condensate produced in the steam reformation process through indirect heat exchange against mass streams to be cooled and/or coolable, or
by superheating and/or vaporizing a mixture of said condensate and high purity water through indirect heat exchange against mass streams to be cooled and/or coolable.

5. A process according to claim 1, wherein said at least one second steam stream is superheated in heat exchange against hot exhaust gases.

6. A process for generating steam during steam reformation, said process comprising:
generating at least one first steam stream in a steam reforming process by vaporizing a water stream through indirect heat exchange with synthesis gas discharged from the steam reformer and/or exhaust gas discharged from the steam reformer,
generating at least one second steam stream in said steam reforming process by vaporizing a water stream through indirect heat exchange with synthesis gas discharged from the steam reformer and/or exhaust gas discharged from the steam reformer,
using said at least one first steam stream completely in the steam reformation process as steam feed for the steam reformer, and
discharging said at least one second steam stream from the steam reforming process for use externally,
wherein said at least one second steam stream is generated by vaporizing degassed and demineralized water.

7. A process according to claim 1, wherein said at least one second steam stream has a higher purity than said at least one first steam stream.

8. An apparatus for generating steam in a steam reformation unit, said apparatus comprising:
means for generating at least one first steam stream,
means for generating at least one second steam stream,
means for using said at least one the first steam stream within a steam reformer, and
means for discharging said at least one second steam stream from the steam reformation unit,
wherein said steam reformer is equipped with a steam generation unit for generating said at least one second steam stream, said steam generation unit having means for introducing high purity water which is degassed and demineralized water.

9. An apparatus according to claim 8, wherein said steam generation unit comprises heat exchangers which can remove heat from mass streams to be cooled and/or which are coolable by indirect heat exchange and can transfer the heat to high purity water and/or steam generated from high purity water.

10. An apparatus according to claim 8, wherein said steam reformer is further equipped with another steam generation unit for generating at least one first steam stream, said further steam generation unit having means for introducing condensate produced in the steam reformation process, or a mixture of said condensate and high purity water.

11. An apparatus according to claim 10, wherein said further steam generation unit comprises heat exchangers which can remove heat from mass streams to be cooled and/or which are coolable by indirect heat exchange and can transfer the heat to said condensate, a mixture of said condensate and high purity water, steam generated from said condensate, and/or steam generated from a mixture of said condensate and high purity water.

12. An apparatus for generating steam during steam reformation, said apparatus comprising:
a steam reformer having inlet means for introducing hydrocarbon feed and steam, a first outlet means removing exhaust gas, and a second outlet means removing synthesis gas,
means for generating at least one first steam stream by vaporizing a water stream through indirect heat exchange with synthesis gas discharged from said steam reformer and/or exhaust gas discharged from said steam reformer,
means for generating at least one second steam stream by vaporizing a water stream through indirect heat exchange with synthesis gas discharged from said steam reformer and/or exhaust gas discharged from said steam reformer,
means for conveying said at least one first steam stream from said means for generating to said inlet means for introducing hydrocarbon feed and steam to said steam reformer,
means for conveying said at least second steam stream from the steam reforming system to an external use, and
means for conveying a degassed and demineralized water stream to said means for generating at least one second steam stream wherein said at least one second steam stream is generated by vaporizing degassed and demineralized water.
